(19) United States
(12) Patent Application Publication
(10) Pub. No.: US 2025/0298370 A1
(43) Pub. Date: Sep. 25, 2025

(54) IMAGE FORMING APPARATUS

(71) Applicant: FUJIFILM Business Innovation Corp., Tokyo (JP)

(72) Inventor: Fuyuki KOKUBU, Kanagawa (JP)

(73) Assignee: FUJIFILM Business Innovation Corp., Tokyo (JP)

(21) Appl. No.: 18/749,592

(22) Filed: Jun. 20, 2024

(30) Foreign Application Priority Data
Mar. 25, 2024 (JP) 2024-048590

(51) Int. Cl. G03G 21/20

(52) U.S. Cl. CPC G03G 21/206

(57) ABSTRACT

An image forming apparatus includes an operation target part that is disposed in a body of the image forming apparatus and on which an operation is performed by an operator with respect to the image forming apparatus, plural cooling target parts that are disposed in the body of the image forming apparatus, that are cooled, and that extend in a direction from a surface of the body of the image forming apparatus at which the operation is performed toward a facing surface facing the surface at which the operation is performed, an introduction part that is disposed on one lateral side with respect to the surface of the body of the image forming apparatus at which the operation is performed and through which a cooling gas is introduced, a guide part that guides the gas introduced through the introduction part at any one of the surface at which the operation is performed or the facing surface facing the surface at which the operation is performed, the guided gas being blown out from any one of the surface at which the operation is performed or the facing surface to the other of the surface at which the operation is performed or the facing surface through the guide part, and a discharge part that is disposed at one side portion facing another side portion, at which the introduction part is disposed, and through which the gas is discharged.

### CROSS-REFERENCE TO RELATED APPLICATIONS

This application is based on and claims priority under 35 USC 119 from Japanese Patent Application No. 2024-048590 filed Mar. 25, 2024.

### BACKGROUND

### (i) Technical Field

The present invention relates to an image forming apparatus.

### (ii) Related Art

Regarding a technique of cooling a temperature-rising portion in an image forming apparatus, techniques described in JP2017-161623A ([0033], to [0065], and FIGS. 8 to 10), JP2011-242635A ([0044] to and FIG. 3), and JP2013-225055A ([0031] to and FIGS. 1B and 2) as follows are already known in the related art.

Described in JP2017-161623A ([0033], to [0065], and FIGS. 8 to 10) is a configuration in which a cooling device (80) installed in a drawer unit (76) cools a waste toner transport path (61) that is above the cooling device (80). The cooling device (80) of JP2017-161623A ([0033], to [0065], and FIGS. 8 to 10) has a configuration in which a gas sucked from a front side is sent to a rear side. In the technique described in JP2017-161623A ([0033], to [0065], and FIGS. 8 to 10), a first exhaust port (87) is formed at an upper portion of a duct (82) of the cooling device (80) and an air stream is sent from the first exhaust port (87) to the waste toner transport path (61) that is positioned behind and above the first exhaust port (87). In addition, a second exhaust port (88) is formed at a rear end of the duct (82) and a body-side waste toner transport unit (90) is cooled by an air stream from the second exhaust port (88).

Described in JP2011-242635A ([0044] to and FIG. 3) is a configuration in which four toner bottles (301) are disposed along a front-rear direction and air sucked through an air intake port (501) provided at a rear portion is discharged through an exhaust port (503) on a lateral side after crossing, in a right-left direction, central portions of the four toner bottles (301) in a longitudinal direction.

Described in JP2013-225055A ([0031] to and FIGS. 1B and 2) is a configuration in which heat sinks (51) are disposed on a side surface of a development container (21) extending in a front-rear direction and an air duct (50) extending in the front-rear direction along the heat sinks (51) is installed. In JP2013-225055A ([0031] to and FIGS. 1B and 2), an air flow (B) that flows through the air duct (50) in a direction from a front side to a rear side is used to cool the development container (21) via the heat sinks (51).

### SUMMARY

Aspects of non-limiting embodiments of the present disclosure relate to an image forming apparatus that provides suppression of an increase in size of the image forming apparatus in comparison with a configuration in which a cooling gas flows along a front-rear direction of the image forming apparatus and improvement of cooling performance for a plurality of cooling targets in comparison with a configuration in which a cooling gas flows in a right-left direction of the image forming apparatus.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including an operation target part that is disposed in a body of the image forming apparatus and on which an operation is performed by an operator with respect to the image forming apparatus, a plurality of cooling target parts that are disposed in the body of the image forming apparatus, that are cooled, and that extend in a direction from a surface of the body of the image forming apparatus at which the operation is performed toward a facing surface facing the surface at which the operation is performed, an introduction part that is disposed on one lateral side with respect to the surface of the body of the image forming apparatus at which the operation is performed and through which a cooling gas is introduced, a guide part that guides the gas introduced through the introduction part at any one of the surface at which the operation is performed or the facing surface facing the surface at which the operation is performed, the guided gas being blown out from any one of the surface at which the operation is performed or the facing surface to the other of the surface at which the operation is performed or the facing surface through the guide part, and a discharge part that is disposed at one side portion facing another side portion, at which the introduction part is disposed, and through which the gas is discharged.

### BRIEF DESCRIPTION OF THE DRAWINGS

Exemplary embodiment(s) of the present invention will be described in detail based on the following figures, wherein:

FIG. 1 is an explanatory view of an image forming apparatus of Example 1;

FIG. 2 is a subsequent explanatory view of the image forming apparatus shown in FIG. 1;

FIG. 3 is a view of a developing agent transportation mechanism portion of Example 1 as seen from above; and

FIG. 4 is a perspective view of the developing agent transportation mechanism portion of Example 1.

### DETAILED DESCRIPTION

Next, an example as a specific example of an exemplary embodiment of the present invention will be described with reference to the drawings. However, the present invention is not limited to an example as follows.

For the sake of easy understanding of the following description, in the drawings, a front-rear direction (a width direction of a medium) will be referred to as an X-axis direction, a right-left direction (a transportation direction of the medium) will be referred to as a Y-axis direction, and a vertical direction will be referred to as a Z-axis direction. Directions and sides represented by arrows X, −X, Y, −Y, Z, and −Z are a frontward direction, a rearward direction, a rightward direction, a leftward direction, an upward direction, a downward direction, a front side, a rear side, a right side, a left side, an upper side, and a lower side, respectively.

In addition, in the drawings, a circle with a point therein means an arrow from the back of the paper to the front of the paper and a circle with a cross therein means an arrow from the front of the paper to the back of the paper.

In the following description which will be made by using the drawings, members other than members necessary for the description are not shown as appropriate for the sake of easy understanding.

### EXAMPLE 1

### Description of Overall Configuration of Printer U in Example 1

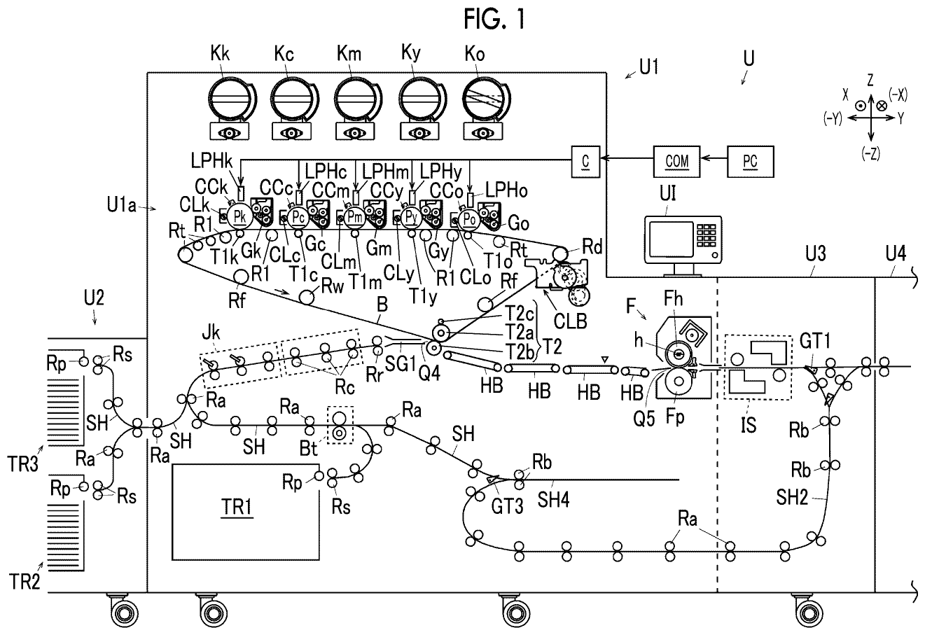

FIG. 1 is an explanatory view of an image forming apparatus of Example 1.

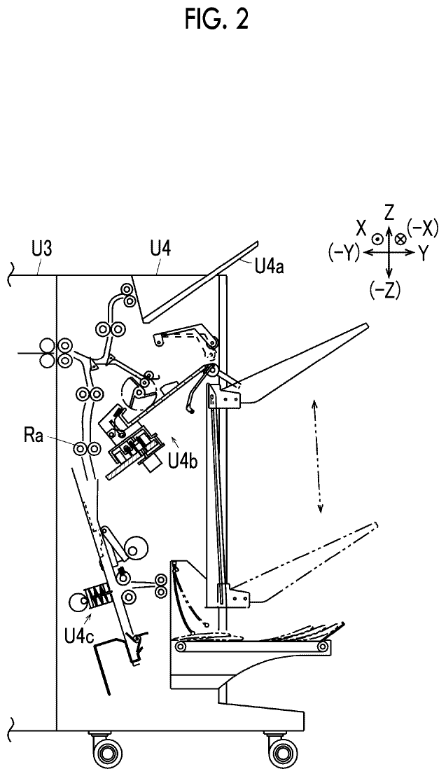

FIG. 2 is a subsequent explanatory view of the image forming apparatus shown in FIG. 1.

In FIGS. 1 and 2, a printer U, which is an example of the image forming apparatus in Example 1 of the present invention, includes a printer body U1, a feeder unit U2 which is an example of a medium supplying device, an operation unit U1, an inspection device U3, and a finisher U4 which is an example of a post processing device.

The feeder unit U2 supplies a medium to the printer body U1. The operation unit U1 is used for a user to perform an input operation or to check the setting or the state of the printer U. The inspection device U3 performs inspection on a formed image. The finisher U4 performs, with respect to a recording sheet S on which printing has been performed, post processing such as alignment, edge binding, and saddle stitch binding.

### Description of Configuration Related to Marking in Example 1

In FIG. 1, the printer body U1 includes a control unit (an example of a control part) C that controls the printer U. In addition, a printing image server COM, which is an example of an information transmission device, is connected to the printer body U1 via a dedicated cable (not shown). A personal computer PC, which is an example of an image transmission device is connected to the printing image server COM via a cable or a line such as a local area network (LAN). The personal computer PC transmits information about an image to be printed by the printer U to the printing image server COM, and the printing image server COM transmits the information of the image to the printer body U1.

A marking unit U1a, which is an example of a recording part that records an image on a medium, is provided inside the printer body U1. The marking unit U1a includes, as examples of image holding parts, photoreceptors Py, Pm, Pc, and Pk of respective colors which are yellow (Y), magenta (M), cyan (C), and black (K) and a photoreceptor Po for a transparent toner or a special color that is used in a case where a special image such as a corporate color is to be formed.

In FIG. 1, around the photoreceptor Pk for black, a charger CCk which is an example of a charging part, an exposure machine LPHk which is an example of a latent image forming part, a developing machine Gk which is an example of a development part, a primary transfer roll T1k which is an example of a primary transfer part, and a photoreceptor cleaner CLk which is an example of a cleaning part for the image holding part are disposed along a rotation direction of the photoreceptor Pk.

Similarly, around the other photoreceptors Py, Pm, Pc, and Po, chargers CCy, CCm, CCc, and CCo, exposure machines LPHy, LPHm, LPHc, and LPHo, developing machines Gy, Gm, Gc, and Go, primary transfer rolls T1y, T1m, T1c, and T1o, and photoreceptor cleaners CLy, CLm, CLc, and CLo are disposed.

Toner cartridges Ky, Km, Kc, Kk, and Ko, which are examples of a developing agent accommodation part, are attachably and detachably supported above the marking unit Ula. The toner cartridges Ky to Ko accommodate developing agents with which the developing machines Gy to Go are replenished.

The chargers CCy to CCo, the exposure machines LPHy to LPHo, the developing machines Gy to Go, and the like constitute image forming parts CCy to CCo, LPHy to LPHo, and Gy to Go of Example 1, which form developing agent images on the photoreceptors Py to Po.

Below the photoreceptors Py to Po, an intermediate transfer belt B, which is an example of an intermediate transfer part and is an example of an image holding part, is disposed. The intermediate transfer belt B is interposed between the photoreceptors Py to Po and the primary transfer rolls T1y to T1o. A rear surface of the intermediate transfer belt B is supported by a drive roll Rd which is an example of a driving part, tension rolls Rt which are examples of a tension applying part, a walking roll Rw which is an example of a meandering prevention part, a plurality of idler rolls Rf which are examples of a driven part, a backup roll T2a which is an example of a facing part for secondary transfer, a plurality of retracting rolls R1 which are examples of a movable part, and the primary transfer rolls T1y to T1o.

On a surface of the intermediate transfer belt B, a belt cleaner CLB which is an example of a cleaning part for the intermediate transfer part is disposed in the vicinity of the drive roll Rd.

A secondary transfer roll T2b which is an example of a secondary transfer member is disposed to face the backup roll T2a with the intermediate transfer belt B interposed therebetween. In addition, the backup roll T2a is in contact with a contact roll T2c which is an example of a contact part. The contact roll T2c applies, to the backup roll T2a, a voltage having a polarity opposite to a developing agent charging polarity.

The backup roll T2a, the secondary transfer roll T2b, and the contact roll T2c constitute a secondary transferer T2 which is an example of a secondary transfer part of Example 1. In addition, the primary transfer rolls T1y to T1o, the intermediate transfer belt B, the secondary transferer T2, and the like constitute transfer devices T1, B, and T2 which are examples of a transfer part of Example 1.

Below the secondary transferer T2, a paper feed tray TR1 is provided as an example of an accommodation part. The recording sheet S which is an example of a medium is accommodated in the paper feed tray TR1. A pickup roll Rp which is an example of an extraction part and a separation roll Rs which is an example of a separation part are disposed above and to the right of the paper feed tray TR1. A transportation path SH through which the recording sheet S is transported extends from the separation roll Rs. A plurality of transportation rollers Ra, which are examples of a transportation part that transports the recording sheet S to a downstream side, are disposed along the transportation path SH.

A deburring device Bt, which is an example of an unnecessary portion removing part, is disposed downstream of the separation roll Rs. The deburring device Bt performs removal of an unnecessary portion (a so-called burr) of an edge of the recording sheet S with the recording sheet S transported to the downstream side while being nipped at a pre-set pressure.

A multi-feed detection device Jk is disposed downstream of the deburring device Bt. The multi-feed detection device Jk measures the thickness of the recording sheet S passing therethrough to detect a state where a plurality of the recording sheets S overlap each other (so-called multi-feed).

Correction rolls Rc which are examples of a posture correction part are disposed downstream of the multi-feed detection device Jk. The correction rolls Rc correct inclination of the recording sheet S with respect to the transportation direction (so-called skew).

A registration roll Rr, which is an example of an adjustment part that adjusts the timing of transportation of the recording sheet S to the secondary transferer T2, is disposed downstream of the correction rolls Rc. In addition, a sheet guide SG1, which is an example of a medium guide part, is disposed downstream of the registration roll Rr.

Note that, the feeder unit U2 is also provided with paper feed trays TR2 and TR3 and the like which are configured in the same manner as the paper feed tray TR1, the pickup roll Rp, the separation roll Rs, and the transportation rollers Ra and the transportation path SH from the paper feed trays TR2 and TR3 joins the transportation path SH of the printer body U1 at a position upstream of the multi-feed detection device Jk.

A plurality of transportation belts HB, which are examples of a medium transportation part, are disposed downstream of the secondary transfer roll T2b in the transportation direction of the recording sheet S.

A fixing device F, which is an example of a fixing part, is disposed downstream of the transportation belts HB in the transportation direction of the recording sheet S.

The image forming parts CCy to CCo, LPHy to LPHo, and Gy to Go, the transfer devices T1, B, and T2, the fixing device F, and the like constitute the marking unit U1a of Example 1.

An inspection device IS, which is an example of an image reading part, is disposed in the inspection device U3 disposed downstream of the fixing device F.

The transportation path SH is formed downstream of the inspection device IS. The transportation path SH extends toward the finisher U4. In addition, an inversion path SH2, which is an example of a transportation path branching off from the transportation path SH, is formed downstream of the inspection device IS. At a place where the inversion path SH2 branches off from the transportation path SH, a first gate GT1, which is an example of a transportation direction switching part, is disposed. The plurality of the transportation rollers Ra, which are examples of a transportation part, are disposed on the inversion path SH2.

A turn-back path SH4 for reversal of the transportation direction of the recording sheet S (a so-called switch-back operation), is disposed downstream of the inversion path SH2 while being disposed below the fixing device F. A switchback roll Rb, which is an example of a transportation part capable of forward rotation and backward rotation, is disposed on the turn-back path SH4. In addition, at the entrance of the turn-back path SH4, a third gate GT3, which is an example of a transportation direction switching part, is disposed.

Note that, the transportation path SH disposed downstream of the turn-back path SH4 joins the transportation path SH of the paper feed tray TR1.

In FIG. 2, the finisher U4 disposed downstream of the inspection device IS includes a top tray U4a which is an example of a loading part, an edge binding device U4b which is an example of a first post processing part, and a saddle stitch binding device U4c which is an example of a second post processing part. The recording sheet S is discharged and loaded on the top tray U4a without being subjected to post processing. The edge binding device U4b can discharge the recording sheets S after binding up end portions of the recording sheets S with a stapler or discharge the recording sheets S in a state where sides of a plurality of the recording sheets S are aligned and the recording sheets S are not bound up. The saddle stitch binding device U4c can discharge the recording sheets S after stapling center portions of the recording sheets S and folding the recording sheets S in two. Note that the configuration of the finisher U4 is not limited to the configuration described as an example. For example, as an example of the post processing, using a finisher having a function of forming a punch hole or a function of folding a recording sheet in three (so-called Z-folding or C-folding) can be adopted.

### Marking Operation

In a case where the printer U receives image information transmitted from the personal computer PC via the printing image server COM, a job, which is an image forming operation, is started. In a case where the job is started, the photoreceptors Py to Po, the intermediate transfer belt B, and the like rotate.

The photoreceptors Py to Po are rotationally driven by a drive source (not shown).

A pre-set voltage is applied to the chargers CCy to CCo such that the surfaces of the photoreceptors Py to Po are charged.

The exposure machines LPHy to LPHo, which are examples of a latent image forming device and are examples of an exposure device, output light for the writing of a latent image in response to a control signal from the control unit C such that electrostatic latent images are written on the charged surfaces of the photoreceptors Py to Po.

The developing machines Gy to Go develop the electrostatic latent images on the surfaces of the photoreceptors Py to Po.

The toner cartridges Ky to Ko perform replenishment of developing agents consumed due to development in the developing machines Gy to Go.

A primary transfer voltage having a polarity opposite to the developing agent charging polarity is applied to the primary transfer rolls T1y to T1o and visible images on the surfaces of the photoreceptors Py to Po are transferred to the surface of the intermediate transfer belt B.

The photoreceptor cleaners CLy to CLo remove, after primary transfer, developing agents remaining on the surfaces of the photoreceptors Py to Po to clean the surfaces.

In a case where the intermediate transfer belt B passes through a primary transfer region facing the photoreceptors Py to Po, images are transferred and superimposed onto the intermediate transfer belt B in the order of O, Y, M, C, and K and the intermediate transfer belt B passes through a secondary transfer region Q4 facing the secondary transferer T2. Note that, in the case of a monochromatic image, an image having only one color is transferred and sent to the secondary transfer region Q4.

The pickup roll Rp feeds the recording sheet S from the paper feed trays TR1 to TR3, to which the recording sheets S are supplied, in accordance with the size of received image information, designation of the recording sheet S, and the sizes, the types, and the like of the recording sheets S accommodated therein.

The separation roll Rs separates the recording sheets S fed from the pickup roll Rp one by one.

The deburring device Bt applies a pre-set pressure to the recording sheet S passing therethrough to perform deburring.

The multi-feed detection device Jk detects the thickness of the recording sheet S passing therethrough to detect multi-feed of the recording sheet S.

The correction rolls Rc correct skew by bringing the recording sheet S passing therethrough into contact with a wall surface (not shown).

The registration roll Rr feeds the recording sheet S in accordance with a time at which an image on the surface of the intermediate transfer belt B is sent to the secondary transfer region Q4.

The sheet guide SG1 guides the recording sheet S fed by the registration roll Rr to the secondary transfer region Q4.

At the secondary transferer T2, a secondary transfer voltage having the same polarity as the pre-set developing agent charging polarity is applied to the backup roll T2a via the contact roll T2c such that the image on the intermediate transfer belt B is transferred to the recording sheet S.

The belt cleaner CLB removes, after the image is transferred at the secondary transfer region Q4, a developing agent remaining on the surface of the intermediate transfer belt B to clean the surface.

The transportation belts HB hold the recording sheet S, onto which the image has been transferred by the secondary transferer T2, with the surfaces thereof and transport the recording sheet S to a downstream side.

The fixing device F includes a heating roll Fh which is an example of a heating member and a pressing roll Fp which is an example of a pressing member. A heater h which is an example of a heat source is accommodated in the heating roll Fh. The fixing device F fixes an unfixed image on a surface of the recording sheet S by heating and pressing the recording sheet S passing through a fixation region Q5 where the heating roll Fh and the pressing roll Fp come into contact with each other. The heating roll Fh and the pressing roll Fp constitute fixing members Fp and Fh in Example 1.

The inspection device IS reads an image on the recording sheet S passing through the fixing device F to inspect the defects of the image.

In a case where two-sided printing is to be performed, the first gate GT1 is operated such that the recording sheet S passing through the inspection device IS is transported to the inversion path SH2, the recording sheet S is switched back at the turn-back path SH4, and the recording sheet S is fed to the registration roll Rr again through the transportation path SH so that printing is performed for the second time.

The recording sheet S passing through the inspection device IS is transported into the finisher U4.

The recording sheet S transported into the finisher U4 is transported to any of the top tray U4a, the edge binding device U4b, or the saddle stitch binding device U4c in accordance with the type of set post processing. The recording sheet S sent to the edge binding device U4b is discharged after being subjected to edge binding processing. The recording sheet S sent to the saddle stitch binding device U4c is discharged after being subjected to saddle stitch binding processing.

### Description of Developing Agent Transportation Device and Cooling Mechanism

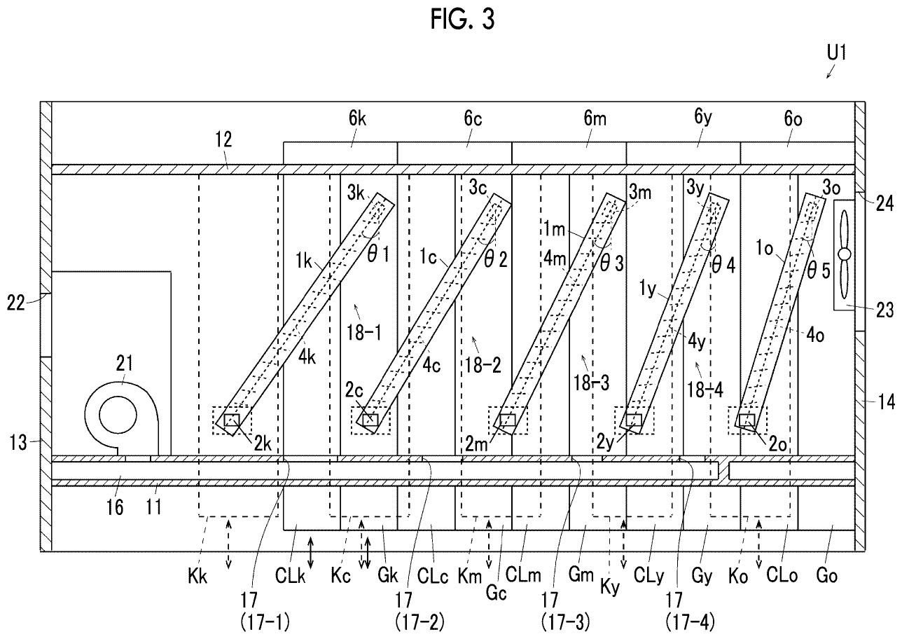

FIG. 3 is a view of a developing agent transportation mechanism portion of Example 1 as seen from above.

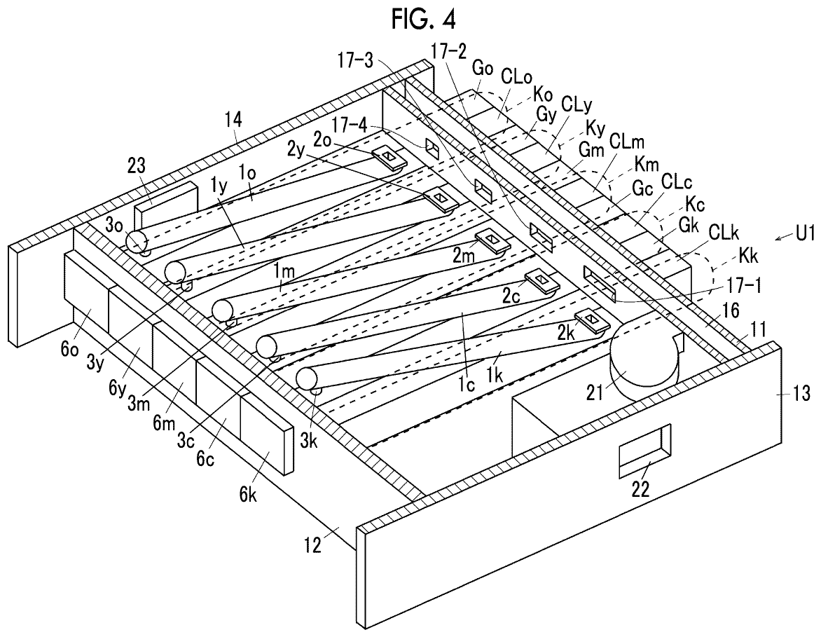

FIG. 4 is a perspective view of the developing agent transportation mechanism portion of Example 1.

In FIGS. 3 and 4, in the printer U of Example 1, using the photoreceptors Py to Po, the developing machines Gy to Go, and the photoreceptor cleaners CLy to CLo causes the photoreceptors Py to Po, the developing machines Gy to Go, and the photoreceptor cleaners CLy to CLo to wear over time. In addition, the toner cartridges Ky to Ko are emptied as developing agents in the toner cartridges Ky to Ko are used and consumed. Therefore, the photoreceptors Py to Po, the developing machines Gy to Go, the photoreceptor cleaners CLy to CLo, and the toner cartridges Ky to Ko, which are examples of an operation target part, are replaceable with new photoreceptors, developing machines, photoreceptor cleaners, and toner cartridges.

In the printer U of Example 1, the toner cartridges Ky to Ko and the like are disposed along the front-rear direction. Therefore, in the printer U of Example 1, in a case where an operator performs an operation of replacing replaceable units such as the toner cartridges Ky to Ko and the developing machines Gy to Go, the operator can perform the operation of replacing the replaceable units by inserting and extracting the replaceable units in the front-rear direction, which is an operation direction, in front of the printer U.

The toner cartridges Ky to Ko, which are examples of a second operation target part of Example 1, are disposed above the photoreceptors Py to Po, the developing machines Gy to Go, and the photoreceptor cleaners CLy to CLo which are examples of a first operation target part. In addition, the diameters of the toner cartridges Ky to Ko of Example 1 are larger than the diameters of developing rolls of the developing machines Gy to Go, and thus the amount of the developing agents accommodated in the toner cartridges Ky to Ko is large. Therefore, the widths of the five toner cartridges Ky to Ko in the right-left direction are larger than the widths of the five developing machines Gy to Go in the right-left direction.

The toner cartridges Ky to Ko and the developing machines Gy to Go are respectively connected to each other by transportation pipes 1y, 1m, 1c, 1k, and 1o which are examples of a cooling target part and are examples of a transportation part. In one end portion (a front end portion) of each of the transportation pipes 1y to 1o, inlet ports 2y, 2m, 2c, 2k, and 2o which are examples of an inlet portion are formed. Developing agents from the toner cartridges Ky to Ko flow into the inlet ports 2y to 2o. In the other end portion (a rear end portions) of each of the transportation pipes 1y to 1o, outlet ports 3y to 3o which are examples of an outlet portion are formed. Through the outlet ports 3y, 3m, 3c, 3k, and 3o, developing agents flow toward the developing machines Gy to Go.

The transportation pipes 1y to 1o of Example 1 are disposed to be inclined with respect to the front-rear direction, which is the operation direction. Therefore, the large-capacity toner cartridges Ky to Ko and the small-size developing machines Gy to Go are connected to each other by the transportation pipes 1y to 1o that are obliquely inclined.

Particularly, regarding the transportation pipes 1y to 1o of Example 1, the angle of inclination of the transportation pipe 1k, which is disposed on a leftmost side, with respect to the front-rear direction is largest. In addition, the closer to a right side a transportation pipe is, the smaller the angle of inclination thereof is and the angle of inclination of the transportation pipe 1o, which is disposed on a rightmost side, is smallest. Transportation augers 4y, 4m, 4c, 4k, and 40 which are examples of a transportation part are disposed in the transportation pipes 1y to 1o. The transportation augers 4y to 40 transport developing agents from the inlet ports 2y to 2o to the outlet ports 3y to 3o by being driven by motor units 6y, 6m, 6c, 6k, and 60 disposed at a rear end portion.

An upper portion of the printer body U1 of Example 1 is provided with a front frame 11, a rear frame 12, a left frame 13, and a right frame 14 which are examples of a frame body. The front frame 11 is disposed at a front portion of the printer body U1 and is formed in a plate-like shape extending in the right-left direction. The front frame 11 of Example 1 is formed to have a length enough to cover the entire width of the printer body U1 in the right-left direction.

The front frame 11 is disposed such that the height thereof in the vertical direction corresponds to the positions of the transportation pipes 1y to 1o. Therefore, the toner cartridges Ky to Ko which are the examples of the second operation target part are attached and detached through a space above the front frame 11, and the developing machines Gy to Go, the photoreceptors Py to Po, and the like which are the examples of the first operation target part are attached and detached through a space below the front frame 11.

A duct 16 which is an example of a guide part is formed in the front frame 11. The duct 16 extends in the right-left direction along the front frame 11. Therefore, the duct 16 guides an internal gas along the right-left direction.

Air outlet ports 17 which are examples of an air outlet part are formed in a rear surface of the front frame 11. The air outlet ports 17 of Example 1 include four air outlet ports 17-1, 17-2, 17-3, and 17-4. The first air outlet port 17-1 is disposed between a front end of the transportation pipe 1k for a color K and a front end of the transportation pipe 1c for a color C. The second air outlet port 17-2 is disposed between a front end of the transportation pipe 1c for the color C and a front end of the transportation pipe 1m for a color M. The third air outlet port 17-3 is disposed between the front end of the transportation pipe 1m for the color M and a front end of the transportation pipe 1y for a color Y. The fourth air outlet port 17-4 is disposed between the front end of the transportation pipe 1y for the color Y and the front end of the transportation pipe 1o for a special color.

Through each of the air outlet ports 17-1 to 17-4 of Example 1, a cooling gas (air) is blown in a direction from a front side to a rear side of the printer body U1 provided with the duct 16.

The size, that is, the opening area of each of the air outlet ports 17-1 to 17-4 is set based on air pressure loss. In Example 1, a gas is likely to flow in a direction along the duct 16 linearly extending in the right-left direction. Therefore, in a case where the opening areas of all of the air outlet ports 17-1 to 17-4 are equal to each other, the largest amount of air is likely to be blown out from the fourth air outlet port 17-4 on the most downstream side, which is a right side (an example of the other side portion) of the printer body U1, and air is less likely to be blown out from the first air outlet port 17-1 on the most upstream side, which is a left side (an example of one side portion) of the printer body U1. Therefore, in Example 1, the opening areas of the air outlet ports 17-1 to 17-4 are set such that the closer to the upstream side an air outlet port is, the larger the opening area thereof is and the closer to the downstream side an air outlet port is, the smaller the opening area thereof is. Note that it is preferable that the specific opening areas are set through an experiment or a simulation on pressure loss or the way in which a gas flow, for example.

The rear frame 12 is disposed at a rear end portion of the printer body U1. The rear frame 12 is disposed to face the front frame 11. The motor units 6y to 60 are supported by the rear frame 12.

The left frame 13 and the right frame 14 are disposed on both of right and left sides of the printer body U1.

An intake fan 21 which is an example of a gas transfer part is disposed at the left frame 13. The intake fan 21 sucks outside air through an intake port 22 which is an example of an introduction part formed at a left side surface of the printer body U1. The intake fan 21 transfers a gas sucked from a left side toward the duct 16 ahead of the intake fan 21.

An exhaust fan 23 which is an example of a gas transfer part is disposed at the right frame 14. The exhaust fan 23 discharges a gas through an exhaust port 24 which is an example of a discharge part formed at a right side surface of the printer body U1.

### Action of Example 1

In the printer U of Example 1 which has the above-described configuration, the intake fan 21 and the exhaust fan 23 are operated in a case where a printing operation is started. Accordingly, the outside air sucked by the intake fan 21 is sent to the duct 16 and is blown rearward through the air outlet ports 17-1 to 17-4. A gas blown out through the first air outlet port 17-1 on the most upstream side is sent rearward along a first flow path 18-1 composed of a space surrounded by lower surfaces of the toner cartridges Kk, Kc, Km, and the like that are on an upper side, the transportation pipe 1k for the color K that is on a left side, the transportation pipe 1c for the color C that is on a right side, and the developing machines Gk, Gc, Gm that are on a lower side, and the like.

A gas blown out through the second air outlet port 17-2 is sent rearward along a second flow path 18-2 composed of a space surrounded by lower surfaces of the toner cartridge Kc and the like that are on an upper side, the transportation pipe 1c for the color C that is on a left side, the transportation pipe 1m for the color M that is on a right side, and the developing machine Gc that is on a lower side, and the like.

A gas blown out through the third air outlet port 17-3 is sent rearward along a third flow path 18-3 composed of a space surrounded by lower surfaces of the toner cartridge Km and the like that are on an upper side, the transportation pipe 1m for the color M that is on a left side, the transportation pipe 1y for the color Y that is on a right side, and the developing machine Gm that is on a lower side, and the like.

A gas blown out through the fourth air outlet port 17-4 is sent rearward along a fourth flow path 18-4 composed of a space surrounded by lower surfaces of the toner cartridge Ky and the like that are on an upper side, the transportation pipe 1y for the color Y that is on a left side, the transportation pipe 1o for the special color that is on a right side, and the developing machine Gy that is on a lower side, and the like.

A gas sent to the rear side of the printer body U1 is transferred along the rear frame 12 by the exhaust fan 23 and is then discharged through the exhaust port 24.

Therefore, a gas sucked through the left side of the printer body U1 by the intake fan 21 flows from the front side to the rear side along the transportation pipes 1y to 1o, and then is discharged through the right side of the printer body U1. Therefore, each of the transportation pipes 1y to 1o is cooled by the gas flowing along each of the transportation pipes 1y to 1o. Therefore, even in a case where heat generated at the time of image formation at the image forming parts CCy to CCo, LPHy to LPHo, and Gy to Go reaches the transportation pipes 1y to 1o on an upper side, the transportation pipes 1y to 1o are cooled by the gas. Therefore, problems such as a change in quality of developing agents in each of the transportation pipes 1y to 1o which is caused by heat, aggregation, and poor fluidity due to sticking are suppressed.

Here, in the case of a configuration in which a gas is sucked through a front end of a body of an image forming apparatus and the gas is discharged through a rear end of the body as in configurations described in JP2017-161623A ([0033], to [0065], and FIGS. 8 to 10) and JP2013-225055A ([0031] to and FIGS. 1B and 2), a fan, a blower, or the like needs to be installed at the front end or the rear end of the body. Therefore, in the case of the configurations described in JP2017-161623A ([0033], to [0065], and FIGS. 8 to 10) and JP2013-225055A ([0031] to and FIGS. 1B and 2), there is a problem in that the length of the image forming apparatus in a front-rear direction is made large, which results in an increase in size of the image forming apparatus.

In the case of a configuration in which air flows, in a right-left direction, across a plurality of toner bottles which are long in a front-rear direction as in a configuration described in JP2011-242635A ([0044] to and FIG. 3), cooling is likely to be sufficient on an upstream side of an air stream but cooling is likely to be insufficient on a downstream side. Therefore, in the case of the configuration described in JP2011-242635A ([0044] to and FIG. 3), there is a problem in that there is unevenness in cooling performance with respect to a plurality of cooling targets and the cooling performance is not stable.

However, in the case of the printer U of Example 1, a cooling gas introduced through a left side which is one side is guided to flow from a front side, which is a surface on one side on which an operator performs an operation such as cartridge replacement, to a rear side which is a facing surface on the other side. Then, the gas is discharged through a right side, which is the other side of the printer body U1. Therefore, in the case of the printer U of Example 1, an increase in size of an image forming apparatus is suppressed in comparison with a configuration in which a cooling gas flows in a front-rear direction of an image forming apparatus as in JP2017-161623A ([0033], to [0065], and FIGS. 8 to 10) and JP2013-225055A ([0031] to and FIGS. 1B and 2). In addition, in the case of the printer U of Example 1, the cooling performance with respect to the transportation pipes 1y to 1o, which are a plurality of cooling targets, is improved in comparison with a configuration in which a cooling gas flows in a right-left direction of an image forming apparatus as in JP2011-242635A ([0044] to and FIG. 3).

In recent years, the photoreceptors Py to Po, the developing machines Gy to Go, and the photoreceptor cleaners CLy to CLo tend to be reduced in size in accordance with size reduction of the entire printer U. Meanwhile, the toner cartridges Ky to Ko tend to have a large capacity for a purpose of reducing a frequency at which the toner cartridges Ky to Ko are replaced. Therefore, in a case where intervals between the toner cartridges Ky to Ko are made match intervals between the five small developing machines Gy to Go, it is difficult to make the capacity of the toner cartridges Ky to Ko large. On the contrary, in a case where intervals between the small developing machines Gy to Go are made match intervals between the five large-capacity toner cartridges Ky to Ko, the entire apparatus becomes large. Therefore, intervals between the developing machines Gy to Go that tend to be reduced in size and intervals between the toner cartridges Ky to Ko that tend to be increased in capacity do not coincide with each other. With regard to this, in the printer U of Example 1, the transportation pipes 1y to 1o are disposed to be inclined with respect to the front-rear direction and the right-left direction.

Therefore, in Example 1, the flow paths 18-1 to 18-4 are also inclined with respect to the front-rear direction and the right-left direction. Here, in the case of a configuration in which the flow paths 18-1 to 18-4 are parallel to the front-rear direction, a flowing direction changes by 90 degrees in a case where the air flows to a right side after reaching a rear end. Therefore, flow resistance and pressure loss are likely to be made large, and it becomes difficult for a gas to flow. On the other hand, in a case where the flow paths 18-1 to 18-4 are inclined with respect to the front-rear direction as in Example 1, the flowing direction changes by less than 90 degrees at the rear end. Therefore, flow resistance and pressure loss are likely to be made small, and it becomes easy for a gas to flow. Therefore, the cooling efficiency is likely to be improved in comparison with a case where the flow paths 18-1 to 18-4 are disposed to be parallel to the front-rear direction.

Particularly, in Example 1, the angles of inclination of the transportation pipes 1y to 1o are set such that the closer to an intake side (the left side) a transportation pipe is, the larger the angle of inclination thereof is. That is, the closer to the intake side, the more the degree of the change in flowing direction at the rear end is smaller than 90 degrees and the closer to the intake side, the smaller flow resistance and pressure loss are. Therefore, in the printer U of Example 1, the closer to the first flow path 18-1 on an upstream side to which a gas is less likely to be blown out from the duct 16 on a straight line, the smaller flow resistance and pressure loss are, and the closer to the fourth flow path 18-4 on a downstream side to which the gas is likely to be blown out, the larger flow resistance and pressure loss are. Therefore, in Example 1, the amounts (the flow rates) of gases flowing through the flow paths 18-1 to 18-4 are likely to be made uniform, cooling unevenness is suppressed, and cooling efficiency is likely to be improved in comparison with a case where all the angles of inclination of the transportation pipes 1y to 1o are equal to each other.

Particularly, in Example 1, the sizes of the air outlet ports 17-1 to 17-4 are set based on pressure loss. Therefore, the amounts (the flow rates) of gases flowing through the flow paths 18-1 to 18-4 are likely to be made uniform. Specifically, the opening areas of the air outlet ports 17-1 to 17-4 are set such that the closer to the intake side an air outlet port is, the larger the opening area thereof is and thus the amounts (the flow rates) of gases flowing through the flow paths 18-1 to 18-4 are likely to be made uniform. Therefore, cooling unevenness is suppressed and cooling efficiency is likely to be improved in comparison with a case where the sizes of the air outlet ports 17-1 to 17-4 are uniform.

### MODIFICATION EXAMPLES

Hereinabove, the example of the present invention has been described in detail. However, the present invention is not limited to the above example and various modifications can be made within the scope of the gist of the present invention described in the claims. Modification examples (H01) to (H07) of the present invention will be described below.

(H01) In the above example, the printer U which is an example of the image forming apparatus has been described. However, the present invention is not limited thereto and for example, the printer U can also be composed of a copying machine, a fax machine, or a multifunction machine having a plurality of functions thereof or all of the functions thereof. In addition, the present invention is not limited to an electrophotographic image forming apparatus and the present invention can also be applied to any image forming apparatus such as an inkjet type image forming apparatus or a heat transfer printing type image forming apparatus.

(H02) In the example, the printer U having a configuration in which developing agents of five colors are used has been described. However, the present invention is not limited thereto and for example, the present invention can also be applied to a monochromatic image forming apparatus or a multicolor image forming apparatus in which four or less colors or six or more colors are used.

(H03) In the example, an aspect in which the finisher U4 is provided has been described. However, the present invention is not limited thereto. The present invention can also be applied to an image forming apparatus that does not include the finisher U4.

(H04) In the example, in a case where there is no size reduction of the developing machines Gy to Go and no increase in capacity of the toner cartridges Ky to Ko, the transportation pipes 1y to 1o can be disposed to be parallel to the front-rear direction, or all the angles of inclination of the transportation pipes 1y to 1o can be made equal to each other.

(H05) In the example, the transportation pipes 1y to 1o have been described as examples of a cooling target part. However, the present invention is not limited thereto. For example, the present invention can be applied to cooling of any part that needs to be cooled like the developing machines Gy to Go, the photoreceptor cleaners CLy to CLo, a waste developing agent transportation path extending from the photoreceptor cleaners CLy to CLo, the fixing device F, the primary transfer rolls T1y to T1o, the secondary transfer roll T2b, the backup roll T2a, and the like.

(H06) In the example, a configuration in which the developing agents are transported from the front side to the rear side through the transportation pipes 1y to 1o has been described. However, the present invention is not limited thereto. For example, a configuration in which the developing agents are transported from the rear side to the front side can also be adopted. Similarly, a direction in which a gas flows is not limited to a direction from a left front side to a right rear side and can be changed to any direction such as a direction from a left rear side to a right front side, a direction from the right front side to the left rear side, and a direction from the right rear side to the left front side in accordance with design or specifications.

(H07) In the example, it is desirable that the sizes of the air outlet ports 17-1 to 17-4 are different from each other based on pressure loss, for example. However, the present invention is not limited thereto. A change can be made as appropriate in accordance with required cooling performance, design, or specifications in a case where sufficient cooling can be performed even in a case where the sizes are equal to each other.

### SUPPLEMENTARY NOTE

(((1)))

An image forming apparatus comprising:
an operation target part that is disposed in a body of the image forming apparatus and on which an operation is performed by an operator with respect to the image forming apparatus;
a plurality of cooling target parts that are disposed in the body of the image forming apparatus, that are cooled, and that extend in a direction from a surface of the body of the image forming apparatus at which the operation is performed toward a facing surface facing the surface at which the operation is performed;
an introduction part that is disposed on one lateral side with respect to the surface of the body of the image forming apparatus at which the operation is performed and through which a cooling gas is introduced;
a guide part that guides the gas introduced through the introduction part at any one of the surface at which the operation is performed or the facing surface facing the surface at which the operation is performed, the guided gas being blown out from any one of the surface at which the operation is performed or the facing surface to the other of the surface at which the operation is performed or the facing surface through the guide part; and a discharge part that is disposed at one side portion facing another side portion, at which the introduction part is disposed, and through which the gas is discharged.
   (((2)))

The image forming apparatus according to (((1))), further comprising:
a first operation target part that is composed of a development part for development of a latent image and that is attachable and detachable with respect to the body of the image forming apparatus by the operator; and
a second operation target part that is composed of an accommodation part accommodating a developing agent to be supplied to the development part and that is attachable and detachable with respect to the body of the image forming apparatus by the operator,
wherein the cooling target parts composed of transportation parts, through which the developing agent in the accommodation part is transported to the development part, are provided.
   (((3)))

The image forming apparatus according to (((1))) or (((2))),
wherein the cooling target parts extending in a direction inclined with respect to both of a front-rear direction connecting the surface at which the operation is performed and the facing surface to each other and a right-left direction connecting the one side portion and the other side portion to each other are provided.
   (((4)))

The image forming apparatus according to (((3))),
wherein the plurality of cooling target parts that are arranged in a direction from the other side portion to the one side portion and of which respective directions of inclination change toward the one side portion from the other side portion are provided.
   (((5)))

The image forming apparatus according to any one of (((1))) to (((4))),
wherein the plurality of cooling target parts that are arranged in a direction from the other side portion to the one side portion are provided,
the guide part including an air outlet part that is disposed between the plurality of cooling target parts and through which the guided gas is blown out from any one of the surface at which the operation is performed or the facing surface to the other of the surface at which the operation is performed or the facing surface is provided, and
a size of the air outlet part is set based on pressure loss of air flowing through the guide part.
   (((6)))

The image forming apparatus according to (((5)))
wherein the guide part that linearly extends in a direction from the other side portion to the one side portion is provided, and
regarding a plurality of air outlet parts, a size of an air outlet part that is on a side close to the other side portion is larger than a size of an air outlet part that is on a side close to the one side portion.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an operation target part that is disposed in a body of the image forming apparatus and on which an operation is performed by an operator with respect to the image forming apparatus;
a plurality of cooling target parts that are disposed in the body of the image forming apparatus, that are cooled, and that extend in a direction from a surface of the body of the image forming apparatus at which the operation is performed toward a facing surface facing the surface at which the operation is performed;
an introduction part that is disposed on one lateral side with respect to the surface of the body of the image forming apparatus at which the operation is performed and through which a cooling gas is introduced;
a guide part that guides the gas introduced through the introduction part at any one of the surface at which the operation is performed or the facing surface facing the surface at which the operation is performed, the guided gas being blown out from any one of the surface at which the operation is performed or the facing surface to the other of the surface at which the operation is performed or the facing surface through the guide part; and
a discharge part that is disposed at one side portion facing another side portion, at which the introduction part is disposed, and through which the gas is discharged.

2. The image forming apparatus according to claim 1, further comprising:
a first operation target part that is composed of a development part for development of a latent image and that is attachable and detachable with respect to the body of the image forming apparatus by the operator; and
a second operation target part that is composed of an accommodation part accommodating a developing agent to be supplied to the development part and that is attachable and detachable with respect to the body of the image forming apparatus by the operator,
wherein the cooling target parts composed of transportation parts, through which the developing agent in the accommodation part is transported to the development part, are provided.

3. The image forming apparatus according to claim 1,
wherein the cooling target parts extending in a direction inclined with respect to both of a front-rear direction connecting the surface at which the operation is performed and the facing surface to each other and a right-left direction connecting the one side portion and the other side portion to each other are provided.

4. The image forming apparatus according to claim 3,
wherein the plurality of cooling target parts that are arranged in a direction from the other side portion to the one side portion and of which respective directions of inclination change toward the one side portion from the other side portion are provided.

5. The image forming apparatus according to claim 1,
wherein the plurality of cooling target parts that are arranged in a direction from the other side portion to the one side portion are provided,
the guide part including an air outlet part that is disposed between the plurality of cooling target parts and through which the guided gas is blown out from any one of the surface at which the operation is performed or the facing surface to the other of the surface at which the operation is performed or the facing surface is provided, and
a size of the air outlet part is set based on pressure loss of air flowing through the guide part.

6. The image forming apparatus according to claim 5,
wherein the guide part that linearly extends in a direction from the other side portion to the one side portion is provided, and
regarding a plurality of air outlet parts, a size of an air outlet part that is on a side close to the other side portion is larger than a size of an air outlet part that is on a side close to the one side portion.
